(19) United States
(12) Patent Application Publication
(10) Pub. No.: US 2015/0104571 A1
(43) Pub. Date: Apr. 16, 2015

(54) RELEASE COMPOSITION FOR INHIBITING FREEZE-STICKING OF AGGREGATE TO STEEL AND ALUMINUM

(71) Applicant: AKJ INDUSTRIES, INC., Fort Meyers, FL (US)

(72) Inventors: John C. Cranfill, JR., Pewee Valley, KY (US); John C. Cranfill, III, Lexington, KY (US)

(73) Assignee: AKJ INDUSTRIES, INC., Fort Meyers, FL (US)

(21) Appl. No.: 14/053,425

(22) Filed: Oct. 14, 2013

(51) Int. Cl. C09K 3/18; C23C 28/00; C23C 26/00

(52) U.S. Cl. CPC C09K 3/18; C23C 26/00; C23C 28/00
USPC 427/202; 106/13; 427/180

(57) ABSTRACT

A composition for inhibiting freeze-sticking of aggregate particles to steel or aluminum comprising about 80 wt. % to 100 wt. % sugar beet molasses containing about 30 wt. % to about 40 wt. % water, based on the total weight of the composition, wherein the composition contains no natural protein additive that is not contained in the sugar beet molasses. In another embodiment, the composition comprises about 30 wt. % to about 70 wt. % sugar beet molasses and about 70 wt. % to about 30 wt. % desugared beet molasses, based on the total weight of sugar beet molasses and desugared sugar beet molasses, said composition containing about 30 wt. % to about 50 wt. % water, based on the total weight of the composition. In another embodiment, the composition comprises about 5 wt. % to about 30 wt. % sugar beet molasses and about 95 wt. % to about 70 wt. % MgCl₂ and/or CaCl₂, based on the total weight of sugar beet molasses, MgCl₂ and/or CaCl₂, with about 40 wt. % to about 70 wt. % water, based on the total weight of the composition.

### FIELD OF THE INVENTION

The present invention is directed to a side release agent composition capable of preventing aggregate materials, such as coal, gravel, crushed rock, stone, and sand from sticking to steel and aluminum by coating the aluminum with the side release agent composition. The side release agent composition also may have some freeze conditioning and deicing characteristics to inhibit the aggregate particles from sticking to each other.

### BACKGROUND AND PRIOR ART

The transportation, conveying, and handling of large quantities of aggregate materials such as coal can be difficult in cold weather, wherein cold temperatures can cause moisture present in or on the aggregate material to freeze to thereby bind the individual particles of the aggregate material together to form a large mass, and to cause the particles to stick to or freeze to steel and aluminum bulk containers used to transport the aggregate, such as railroad cars. This phenomenon is referred to herein as “freeze-clumping.” Freeze-clumping can make it difficult to unload railcars or trucks containing coal or other aggregate materials. For instance, the coal can cause damage to hoppers and other receiving equipment. In addition, when unloading a railcar or truck, a large percentage of the load can stick to the bottom and/or sides of the car or truck, causing further difficulties.

Heretofore, the prior art has taught to apply a deicer to the aggregate material and/or a freeze conditioning agent to the inside walls of the transporting equipment. The freeze conditioning agent is an agent that prevents, inhibits or weakens the formation of ice between the inside walls of the transporting equipment, e.g., railcar, and the aggregate material. Generally, freeze conditioning or side release agents may serve under proper conditions to remove ice or snow already present on a surface; this function is known as de-icing, and the same agents that are used for freeze conditioning or side release are sometimes effective for deicing. Freeze conditioning agents may be sprayed onto the coal or other aggregate materials as it is being handled by conveying equipment, such as a conveyor belt, prior to introduction into a railcar or truck.

The prior art has provided various freeze conditioning agents. Chloride salts, in particular calcium and magnesium chloride, are commonly used, but these compounds suffer from a number of drawbacks. The principal drawback with such chloride salts is corrosivity of the conveying and transporting equipment, and also, in the case of coal, of the furnaces in which the coal is fired. Commercial chloride salts may include significant amounts of heavy metals, which are of particular concern because they can adversely affect furnace components and can accumulate in the ash left over after coal combustion, thus causing disposal problems. Due to the solubility of salt solutions, they are not effective as side release agents.

The prior art has also taught to treat coal with diesel fuel. Diesel fuel can be effective in inhibiting freeze-clumping of the coal, and adds combustible caloric content to the coal. However, diesel fuel can degrade conveyor belts used to convey the coal. Moreover, diesel fuel is a non-renewable resource, and can cause environmental problems if fuel drips off (or “leaches” out) of the coal.

Another class of freeze conditioning agents include glycols, in particular ethylene glycol and diethylene glycol. Although effective, these compounds are toxic. Moreover, these glycols are costly.

Desugared sugar beet molasses is a waste product resulting from a process for removing sugar from sugar beet molasses. Desugared sugar beet molasses and sugar cane molasses with or without chloride salts, have been used to prevent the formation of ice and snow on outdoor surfaces, and for deicing surfaces on which snow and ice have formed—see, for example, WO 00/50531, and U.S. Pat. No. 6,149,834. Other forms of molasses, treated or untreated, also have been used as deicers, as disclosed in PCT/EP2012/060543, PCT/US2003/022813, and U.S. Pat. No. 7,033,422. Sugar cane molasses solids and desugared sugar beet molasses solids (U.S. Pat. No. 6,878,308) also have been used to inhibit the freeze-clumping of aggregate materials, such as coal. Sugar beet molasses for deicer compositions has not been used (see U.S. Pat. No. 7,294,285) except when included with a natural protein (see WO 2012/168206 A1). The compositions described herein do not include a natural protein that is not contained in the molasses, and preferably contain no protein additive.

It has been found that sugar beet molasses (untreated—not desugared), alone or together as a mixture with either desugared sugar beet molasses or magnesium chloride or calcium chloride provides unexpected release properties to aggregate, particularly coal, to inhibit the aggregate from freeze-sticking to aluminum and steel.

### SUMMARY

The steel and aluminum release compositions described herein comprise about 30 wt. % to about 100 wt. % sugar beet molasses that has not been desugared (contains at least about 30 wt. % sugars). In another embodiment 30 wt. % to about 70 wt. % sugar beet molasses that has not been desugared (contains at least about 30 wt. % sugars and about 30 wt. % to about 40 wt. % water) together with about 70 wt. % to about 30 wt. % desugared sugar beet molasses (containing about 7 wt. % to about 20 wt. % sugars and about 40 wt. % to about 50 wt. % water). In another embodiment the composition comprises a combination of about 5 wt. % to about 30 wt. % sugar beet molasses with about 70 wt. % to about 95 wt. % MgCl₂ and/or CaCl₂, based on the total weight of sugar beet molasses and MgCl₂ and/or CaCl₂. The MgCl₂ and/or CaCl₂ contain about 65 wt. % to about 75 wt. % water. All of these compositions that contain no MgCl₂ or CaCl₂ salts should contain about 30 wt. % to about 50 wt. % water, based on the total weight of the compositions, for sprayability onto the aggregate and/or onto the floor and/or sides of aluminum and/or steel railcars or other aggregate transporting equipment. In one embodiment, the composition contains a mixture of about 30 wt. % to about 70 wt. % sugar beet molasses and about 70 wt. % to about 30 wt. % desugared sugar beet molasses, based on the total weight of sugar beet molasses and desugared sugar beet molasses. In another, salt containing embodiment, the composition contains about 5 wt. % to about 30 wt. % sugar beet molasses containing about 30 wt. % sugars and about 30 wt. % to about 40 wt. % water, and about 70 wt. % to about 95 wt. % MgCl₂ and/or CaCl₂ that contains about 65 wt. % to about 75 wt. % water. In this salt containing embodiment, the composition contains about 40 wt. % water to about 70 wt. % water, preferably about 60 wt. % to about 70 wt. % water, based on the total weight of the composition.

### DETAILED DESCRIPTION

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

(1) Sugar Beet molasses having about 48 wt. % to about 52 wt. % sugars; (2) desugared sugar beet molasses having about 16 wt. % to about 18 wt. % sugars; (3) sugar beet molasses having about 48 wt. % to about 52 wt. % sugars with MgCl₂; and (4) sugar beet molasses having about 48 wt. % to about 52 wt. % sugars with CaCl₂, all as aqueous solutions containing about 40 wt. % to about 70 wt % water, were tested for side release properties against both steel and aluminum, as follows:

Steel or aluminum coupon plates were placed above a container holding the release compositions. The coupons were lowered into the release composition and then the coupons were raised above the container holding the release composition. The coupons were then drained for one minute. The container was on a scale that reads the negative weight (the amount of material that stays on the coupon plate)—the higher the negative weight (dip weight), the more that adhered to the plate. The coupon plates also were viewed with the naked eye to note whether the coverage is consistent (complete) or spotty—the formulations described and claimed herein give consistent coverage.

After dipping the coupon plates, the plates were laid flat. Coal was ground to a size smaller than 10 mesh and the coal is then dried or moistened to a moisture content of 15 wt. %. The coal was then tamped onto a PVC pipe section that was placed on the treated coupon plate. The plate was then put into a freezer at −10° F. overnight. The next day the plates were removed and held in place. A spring gauge with a strap was fixed around the PVC pipe such that when a screw is turned, the fixed coupon plate is forced away from the PVC pipe. The amount of force it takes to break the PVC pipe free from the plate was measured—the lower the number (grams), the better the product works as a release agent.

| | DIP WT | FORCE | DIP WT | FORCE |
|---|---|---|---|---|
| RELEASE PRODUCT | STEEL | STEEL | AL | AL |
| 50 GPS/50 CMS* | 1.16 | 1546 | 1.18 | 743 |
| 50% crude glycerin | 0.20 | 4372 | 0.14 | 5678 |
| CaCl₂ | 0.17 | 5640 | 0.175 | 7000+ |
| MgCl₂ | 0.45 | 3514 | 0.27 | 5412 |
| 90 MgCl₂/10 GPS** | 0.41 | 3296 | 0.43 | 1299 |
| 85 MgCl₂/15 GPS*** | 0.46 | 3036 | 0.48 | 1595 |
| CMS**** | 0.69 | 7000+ | 0.675 | 6647 |
| 90 CaCl2/10GPS***** | 0.46 | 4263 | 0.46 | 2670 |

*50 wt. % sugar beet molasses (GPS), 50 wt. % desugared sugar beet molasses (CMS) (total water content of 40 wt. %)
**10 wt. % sugar beet molasses (GPS), 90 wt. % MgCl₂ (total water content of 64.7 wt. %)
***15 wt. % sugar beet molasses (GPS), 85 wt. % MgCl₂ (total water content of 64.55 wt. %)
****55% desugared beet molasses (CMS) (total water content of 45 wt. %)
*****10 wt. % sugar beet molasses (GPS), 90 wt. % CaCl₂ (total water content of 68.3 wt. %)
GPS has a water content of 45 wt. %; GPS has a total water content of 35 wt. %; CaCl₂ has a total water content of 72 wt. %; and MgCl₂ has a total water content of 68 wt. %.

As shown in the above data, the addition of sugar beet molasses to MgCl₂ gave no improvement in release properties when tested on the steel coupons, but reduced the force needed to separate the aluminum coupon from 5412 grams to 1299 grams—a surprising reduction of 76%. The combination of sugar beet molasses and desugared beet molasses, at a 50/50 mixture, however, reduced the force needed to separate both steel and aluminum coupons. For the steel coupons, in comparison to a glycerin release agent (50 wt. % crude glycerin, 50 wt. % water), the force was reduced from 3481 grams to 1546 grams—a reduction of almost 56%. For the aluminum coupons, the force was reduced from 1740 grams to 743 grams—a reduction of over 57%.

The combination of sugar beet molasses and desugared sugar beet molasses contained about 25 wt. % to about 35 wt. % sugars, based on the total weight of molasses in the composition, and provided better release than the desugared sugar beet molasses alone. The diluted combination of sugar beet molasses and desugared sugar beet molasses contained about 20 wt. % to about 30 wt. % sugars and about 30 wt. % to about 50 wt. % water, based on the total weight of the compositions.

What is claimed is:

1. A composition for inhibiting freeze-sticking of aggregate particles to steel or aluminum comprising about 80 wt. % to 100 wt. % sugar beet molasses containing about 30 wt. % to about 40 wt. % water, based on the total weight of the composition, wherein the composition contains no natural protein additive that is not contained in the sugar beet molasses.

2. A composition for inhibiting freeze-sticking of aggregate particles to steel or aluminum comprising about 30 wt. % to about 70 wt. % sugar beet molasses and about 70 wt. % to about 30 wt. % desugared beet molasses, based on the total weight of sugar beet molasses and desugared sugar beet molasses, said composition containing about 30 wt. % to about 50 wt. % water, based on the total weight of the composition.

3. A composition for inhibiting freeze-sticking of aggregate particles to aluminum comprising about 5 wt. % to about 30 wt. % sugar beet molasses and about 95 wt. % to about 70 wt. % MgCl₂ and/or CaCl₂, based on the total weight of sugar beet molasses, MgCl₂ and/or CaCl₂, with about 40 wt. % to about 70 wt. % water, based on the total weight of the composition.

4. The composition of claim 2, wherein the sugar beet molasses comprises about 40 wt. % to about 60 wt. % of the composition, based on the total weight of sugar beet molasses and desugared sugar beet molasses.

5. The composition of claim 3, wherein the sugar beet molasses comprises about 5 wt. % to about 20 wt. % of the composition, based on the total weight of sugar beet molasses, CaCl₂ and MgCl₂, and about 60 wt. % to about 70 wt. % water, based on the total weight of the composition.

6. The composition of claim 5, wherein the sugar beet molasses comprises about 5 wt. % to about 15 wt. % of the composition, based on the total weight of sugar beet molasses, MgCl₂ and CaCl₂.

7. The composition of claim 2, wherein the sugar beet molasses comprises about 45 wt. % to about 55 wt. % of the composition, based on the total weight of sugar beet molasses and desugared sugar beet molasses.

8. The composition of claim 3, wherein the sugar beet molasses comprises about 10 wt. % to about 15 wt. % of the composition, based on the total weight of sugar beet molasses, CaCl₂ and MgCl₂.

9. The composition of claim 2, wherein the sugar content of the composition, based on the total weight of sugar beet molasses and desugared sugar beet molasses is about 30 wt. % to about 40 wt. %.

10. A method of inhibiting freeze-sticking of aggregate particles to steel or aluminum comprising applying the composition of claim 1 to the steel or aluminum or to the aggregate particles, and then contacting the steel or aluminum with the aggregate particles.

11. A method of inhibiting freeze-sticking of aggregate particles to aluminum comprising applying the composition of claim 2 to aluminum or to the aggregate particles, and then contacting the aluminum with the aggregate particles.

12. A method of inhibiting freeze-sticking of aggregate particles to steel or aluminum comprising applying the composition of claim 3 to the steel or aluminum or to the aggregate particles, and then contacting the steel or aluminum with the aggregate particles.

13. A method of inhibiting freeze-sticking of aggregate particles to steel or aluminum comprising applying the composition of claim 4 to the steel or aluminum or to the aggregate particles, and then contacting the steel or aluminum with the aggregate particles.

14. A method of inhibiting freeze-sticking of aggregate particles to steel or aluminum comprising applying the composition of claim 5 to the steel or aluminum or to the aggregate particles, and then contacting the steel or aluminum with the aggregate particles.

15. A method of inhibiting freeze-sticking of aggregate particles to steel or aluminum comprising applying the composition of claim 6 to the steel or aluminum or to the aggregate particles, and then contacting the steel or aluminum with the aggregate particles.

16. A method of inhibiting freeze-sticking of aggregate particles to steel or aluminum comprising applying the composition of claim 7 to the steel or aluminum or to the aggregate particles, and then contacting the steel or aluminum with the aggregate particles.

17. A method of inhibiting freeze-sticking of aggregate particles to steel or aluminum comprising applying the composition of claim 8 to the steel or aluminum or to the aggregate particles, and then contacting the steel or aluminum with the aggregate particles.

18. A method of inhibiting freeze-sticking of aggregate particles to steel or aluminum comprising applying the composition of claim 9 to the steel or aluminum or to the aggregate particles, and then contacting the steel or aluminum with the aggregate particles.

19. The method of claim 10, wherein the composition is applied to the steel, aluminum or aggregate particles by spraying.

20. The method of claim 12, wherein the composition is applied to the steel, aluminum or aggregate particles by spraying.
